(19) United States
(12) Patent Application Publication
(10) Pub. No.: US 2023/0316110 A1
(43) Pub. Date: Oct. 5, 2023

(54) METHOD, DEVICE AND SYSTEM FOR PROVIDING AUTOMATED EXPLANATIONS FOR INFERENCE SERVICES BASED ON ARTIFICIAL INTELLIGENCE USING CLOUD

(71) Applicant: ELECTRONICS AND TELECOMMUNICATIONS RESEARCH INSTITUTE, Daejeon (KR)

(72) Inventors: Taeheum NA, Daejeon (KR); Tae Yeon KIM, Daejeon (KR); Seung Hyun YOON, Daejeon (KR)

(73) Assignee: ELECTRONICS AND TELECOMMUNICATIONS RESEARCH INSTITUTE, Daejeon (KR)

(21) Appl. No.: 18/165,409

(22) Filed: Feb. 7, 2023

(30) Foreign Application Priority Data
Mar. 29, 2022 (KR) 10-2022-0039162

(51) Int. Cl. G06N 5/04

(52) U.S. Cl. CPC G06N 5/04

(57) ABSTRACT

Disclosed are a method, device, and system for providing automated explanations for inference services based on artificial intelligence using a cloud. The method includes: requesting an inference response message to an inference container according to an inference service based on an inference request message received from a client; sending the inference request message and the inference response message to an imitation learning container linked with the inference container according to a mirroring setting; and creating interpretation information of the inference container based on the inference request message and the inference response message, and providing the created interpretation information to the client.

### CROSS-REFERENCE TO RELATED APPLICATION

This application claims priority to and the benefit of Korean Patent Application No. 10-2022-0039162 filed in the Korean Intellectual Property Office on Mar. 29, 2022, the entire contents of which are incorporated herein by reference.

### 1. Field of the Invention

The present disclosure relates to a method, device, and system for providing automated explanations for inference services based on artificial intelligence using a cloud, and more specifically, to a method, device, and system for providing automated explanations for inference services based on artificial intelligence for providing interpretation information on causality of inference through an imitation learning container operating independent of an inference container.

### 2. DISCUSSION OF RELATED ART

Recently, with the explosive increase in interest in artificial intelligence (AI), research on improving the explanability (eXplainable AI; XAI) or interpretability of internal processing procedures and inference results, along with the design of a deep neural network (DNN), has also been actively conducted. For example, in the case of a classification model, there are a technique for classifying neurons that have the greatest influence on inference results, a technique for deriving inputs that have the greatest influence on the inference among several input features, and the like. These techniques are only to the extent that operators may roughly understand causes for model decisions. Therefore, research is being conducted so that operators may understand the causal relationship of the model results and understand the model results in detail. At the same time, the case of converting a deep neural network (DNN) into an algorithm form of a new data structure by imitation learning also corresponds to a technique that increases explanability. Therefore, the higher the interpretability of the artificial intelligence model, the easier it is to understand the processes and reasons of the decision or prediction derived from the model.

By increasing the interpretability, the operation of the artificial intelligence models combined with network systems may be understood, and a structure (human in the loop) in which artificial intelligence and humans may collaborate may be implemented. By using this, network operators may understand reasons related to the operation result derived from the model, and may remove uncertainty by approving the operation. In addition, the operators supplement external factors in addition to features that an AI model has not learned, thereby maximizing the operation efficiency.

However, in the conventional method of interpreting a learning model, an inference service user may receive results according to an inference request during creating inference services and using the inference services, but may not still understand a specific causal relationship from which the corresponding result is derived. That is, the user may not acquire interpretation information related to the detailed inference procedure that derives the inference results. For example, because the user may not acquire related interpretation information such as a plurality of input features and importance for each feature that have a great influence on the inference results, the user need to check the inference service results and the analysis results of the model by themselves and personally identify the causes. Accordingly, it is inconvenient for the user to directly estimate and explain the inference procedure.

The above information disclosed in this Background section is only for enhancement of understanding of the background of the invention, and therefore it may contain information that does not form the prior art that is already known in this country to a person of ordinary skill in the art.

### SUMMARY OF THE INVENTION

The present disclosure provides a method, device, and system for providing automated explanations for inference services based on artificial intelligence that provides an explanation of causality of inference through an imitation learning container operating independent of an inference container.

The technical problems of the present disclosure are not limited to the above-described technical problems. That is, other technical problems that are not described may be obviously understood by those skilled in the art to which the present disclosure pertains from the following description.

According to an embodiment of the present disclosure, a method of providing automated explanations for inference services based on artificial intelligence using a cloud includes: requesting an inference response message to an inference container according to an inference service based on an inference request message received from a client; sending the inference request message and the inference response message to an imitation learning container linked with the inference container according to a mirroring setting; and creating interpretation information of the inference container based on the inference request message and the inference response message and providing the created interpretation information to the client.

The inference container and the imitation learning container may have independent learning models, and the imitation learning container may be trained to imitate an inference of the inference container.

The imitation learning container may be created based on an inference service descriptor used to create the inference service, and the inference service descriptor may include state information including first access information and input/output specifications of the inference container.

The mirroring setting may be performed by an ingress setting for mirroring the inference response message to the imitation learning container together with the sent inference request message based on the first access information.

The inference service descriptor may further include an interpretation field indicating provision of the interpretation information and second access information of the imitation learning container. The interpretation field may include a value indicating whether to activate or not, and the second access information may be created according to an ingress setting and have an Internet Protocol (IP) address or a domain name of the imitation learning container for an Application Program Interface (API) setting.

The interpretation information may include at least one of an input feature that acts on an imitation inference result of the imitation learning container and an importance of the input feature.

The creating of the interpretation information and the providing of the created interpretation information to the client may include providing an imitation inference result of the imitation learning container and the inference response message to the client along with the interpretation information when a critical condition is satisfied. The critical condition may be set to a condition in which the imitation inference result of the imitation learning container has a similarity of a reference value or greater with respect to an inference result according to the inference response message.

The creating of the interpretation information and the providing of the created interpretation information to the client may further include continuously training the imitation learning container until the critical condition is satisfied to output the imitation inference result, creating interpretation information of the imitation inference result that satisfies the critical condition, and discarding the imitation inference result that does not satisfy the critical condition.

The method may further include: prior to the requesting of the inference response message, creating the inference service according to a request from the client; sequentially creating the inference container and the imitation learning container based on state information of the inference service; and performing a mirroring setting for sending the inference request message and the inference response message to the imitation learning container based on the state information. The state information may include first access information and input/output specifications of the inference container.

The creating of the inference container may include creating a sub-resource including an ingress layer, a service layer, and an inference container based on the inference service.

According to another embodiment of the present disclosure, a platform device for providing automated explanations for inference services based on artificial intelligence using a cloud includes: a transceiver configured to transmit and receive a signal; and a processor configured to process the signal. The processor may request an inference response message to an inference container according to an inference service based on an inference request message received from a client, send the inference request message and the inference response message to an imitation learning container linked with the inference container according to a mirroring setting, and create interpretation information of the inference container and provide the created interpretation information to the client when the imitation learning container is trained based on the inference request message and the inference response message to satisfy a provision condition.

According to still another embodiment of the present disclosure, a system for providing automated explanations for inference services based on artificial intelligence using a cloud includes: a client configured to request creation or use of an inference service; and a platform device for providing automated explanations for inference services including a processor that processes a request for the inference service. The processor may request an inference response message to an inference container according to an inference service based on an inference request message received from a client, send the inference request message and the inference response message to an imitation learning container linked with the inference container according to a mirroring setting, and create interpretation information of the inference container and provide the created interpretation information to the client when the imitation learning container is trained based on the inference request message and the inference response message to satisfy a provision condition.

The features briefly summarized above with respect to the present disclosure are merely exemplary aspects of the detailed description of the disclosure to be described below, and do not limit the scope of the disclosure.

### BRIEF DESCRIPTION OF THE DRAWINGS

FIG. 1 is an exemplary view of a system for providing automated explanations for inference services based on artificial intelligence using a cloud for explaining the present disclosure.

FIG. 2 is a schematic configuration diagram of a platform device for providing automated explanations for inference services based on artificial intelligence according to an embodiment of the present disclosure.

FIG. 3 is an exemplary diagram illustrating resource association between an ingress layer, a service layer, and an endpoint in the platform device for providing automated explanations for inference services based on artificial intelligence according to an embodiment of the present disclosure.

FIG. 4 is a diagram illustrating an operation of the ingress layer.

FIG. 5 is a flowchart for creating an imitation learning container and a mirroring setting performed in a method of providing automated explanations for inference services based on artificial intelligence according to an embodiment of the present disclosure.

FIG. 6 is an exemplary diagram illustrating a process in which creating of an imitation learning container and mirroring setting are implemented in the platform device for providing automated explanations according to an embodiment of the present disclosure.

FIG. 7 is an exemplary diagram illustrating an inference service descriptor in which the mirroring is set by an ingress setting.

FIG. 8 is a flowchart of a method of providing automated explanations for inference services based on artificial intelligence according to an embodiment of the present disclosure.

FIG. 9 is a diagram illustrating an operation process of an inference container and an imitation learning container for each module in the platform device for providing automated explanations according to an embodiment of the present disclosure.

### DETAILED DESCRIPTION OF EXEMPLARY EMBODIMENTS

Hereinafter, embodiments of the present disclosure will be described in detail with reference to the accompanying drawings so that those skilled in the art to which the present disclosure pertains may easily practice the present disclosure. However, the present disclosure may be modified in various different forms, and is not limited to embodiments described herein.

Further, in describing exemplary embodiments of the present disclosure, well-known functions or constructions will not be described in detail since they may unnecessarily obscure the understanding of the present disclosure. In the drawings, parts not related to the description of the present disclosure are omitted, and similar reference numerals are attached to similar parts.

In the present disclosure, when a component is said to be “connected,” “coupled,” or “connected” to another component, this may include not only a direct connection relationship, but also an indirect connection relationship where still another component is present therebetween. In addition, when a component “includes” or “has” another component, this means that the component may further include other components, not excluding the inclusion of the other components unless otherwise stated.

In the present disclosure, the terms such as first and second are used only for the purpose of distinguishing one component from other components, and do not limit the order, importance, or the like of components unless otherwise specified. Accordingly, within the scope of the present disclosure, a first component in an embodiment may be referred to as a second component in another embodiment, and similarly, a second component in an embodiment may be referred to as a first component in other embodiments.

In the present disclosure, components distinguished from each other are intended to clearly explain each feature, and do not mean that the components are necessarily separated. That is, a plurality of components may be integrated to be formed in a single hardware or software unit, or a single component may be distributed to be formed in a plurality of hardware or software units. Accordingly, even if not described separately, even such integrated or distributed embodiments are included in the scope of the present disclosure.

In the present disclosure, components described in various embodiments do not necessarily mean essential components, and some of the components may be optional components. Therefore, embodiments composed of a subset of components described in an embodiment are also included in the scope of the present disclosure. In addition, embodiments including other components in addition to the components described in various embodiments are also included in the scope of the present disclosure.

Hereinafter, embodiments of the present disclosure will be described with reference to the accompanying drawings.

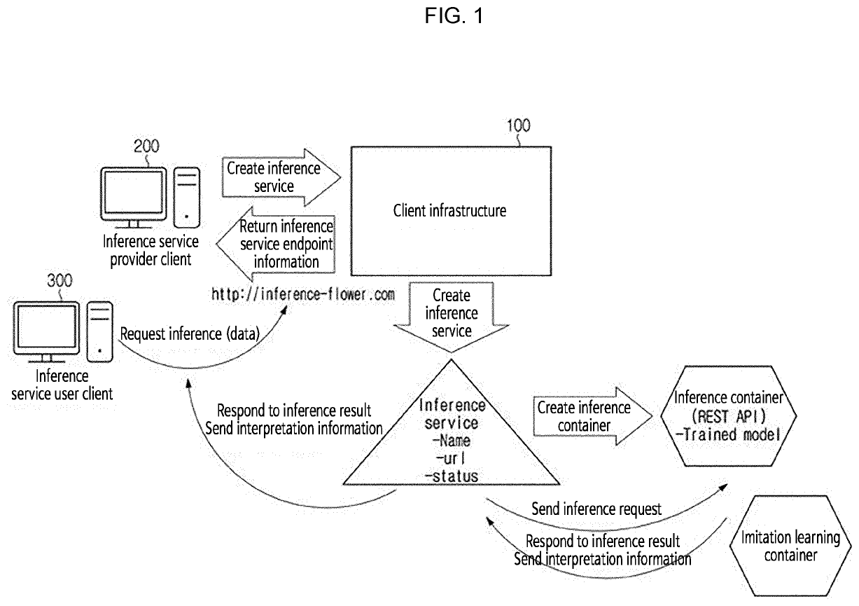

FIG. 1 is an exemplary view of a system for providing automated explanations for inference services based on artificial intelligence using a cloud for explaining the present disclosure.

In a cloud-based inference service, the system for providing automated explanations may include a platform device 100 for providing automated explanations for inference services, an inference service provider client 200, and an inference service user client 300. For convenience of description, the platform device 100 for providing automated explanations for inference services may be described in combination with a cloud infrastructure. The inference service provider client 200 and the inference service user client 300 may be abbreviated as a provider client and a user client, respectively.

The system for providing automated explanations may create a predefined inference container in the cloud infrastructure 100 to provide an inference service when the inference service are requested from the user client 300, for example, in order to increase resource efficiency. In addition, the system for providing automated explanations may provide an imitation inference result and interpretation information describing an inference result of the inference service by an imitation learning container operating independent of the inference container.

The predefined inference container may be allocated at a predetermined location of the cloud infrastructure 100 by a request for creation of the inference service (or inference service module) from the provider client 200. The predefined inference container may have state information that includes, for example, an inference container name (or identifier), storage location information of the inference container, a learning model to be applied to the inference container, runtime information of the learning model, input/output specifications of the inference container, and the like. The storage location information may be, for example, a uniform resource locator (URL). The predefined inference container may be a prototype inference container that is not actually activated by an inference request from the user client 300. The inference container may be, for example, a deep neural network learning model such as a deep neural network (DNN), but is not limited thereto, and may be constituted as various learning models that support the inference service. The cloud infrastructure 100 may have Internet Protocol (IP) addresses or domain names for each endpoint while having a plurality of endpoints that manage various types of inference containers. When there is a request for creation of the predefined inference container, the cloud infrastructure 100 may be controlled by, for example, an ingress controller to form layers, such as an ingress layer and a service layer, which are linked with the inference container. Accordingly, the cloud infrastructure 100 includes at least one server. For example, in the case of a plurality of servers, a server controlling the layers and a server managing the endpoints may be separately provided.

To describe in detail the creation of the predefined inference container and the use of the inference service, the provider client 200 may request the cloud infrastructure 100 to create the inference service. The cloud infrastructure 100 may create the inference service inside. The cloud infrastructure 100 may create an inference service entity serving as an application programming interface (API) server and return endpoint information. The predefined inference container may be managed in association with the inference service entity. The inference service created inside the cloud infrastructure 100 may wait for an API call. When an API related to an inference service request is called by the user client 300, the inference service entity may create an inference container including a trained model to be actually operated. That is, the inference service entity may create an inference container to be actually operated based on the predefined inference container. When the creation of the actual inference container is completed, the cloud infrastructure 100 may request an inference by redirecting the inference request API, acquire an inference result, and return the inference result to the user client 300.

When the inference result is returned, the imitation learning container may send interpretation information describing the imitation inference result and the inference result of the inference container to the user client 300 based on the request and response messages of the inference service. A detailed description of the imitation learning container and the interpretation information will be described below.

As another example, the actual inference container may be created by a request of the inference service from the provider client 200 and wait for an API call from the user client 300 while being allocated to the endpoint. In this case, the predefined inference container may not be created.

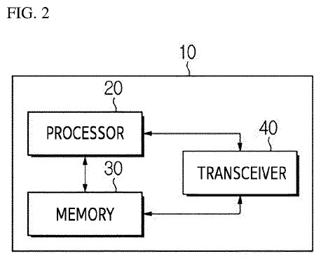

FIG. 2 is a schematic configuration diagram of a platform device for providing automated explanations for inference services based on artificial intelligence according to an embodiment of the present disclosure.

The platform device 100 for providing automated explanations of inference services may be a cloud infrastructure including a server or the like that executes processing related to the creation and use of the inference service. The cloud infrastructure 100 may be a server that includes a control module of layers, storage of a pod to which the inference container and the imitation learning container are allocated, and the like. The control modules and containers of the layers may operate on a single server or may be managed on different servers. For example, a device 10 includes at least one server, and the server may include at least one of a processor 20, a memory 30, and a transceiver 40 for the above-described operation. That is, the device may include configurations necessary to communicate with other devices. Also, as an example, the device may include other components in addition to the above-described components. That is, the device is only a configuration including the above-described device to perform communication with other devices, and is not limited thereto, and may be a device that operates based on the above description.

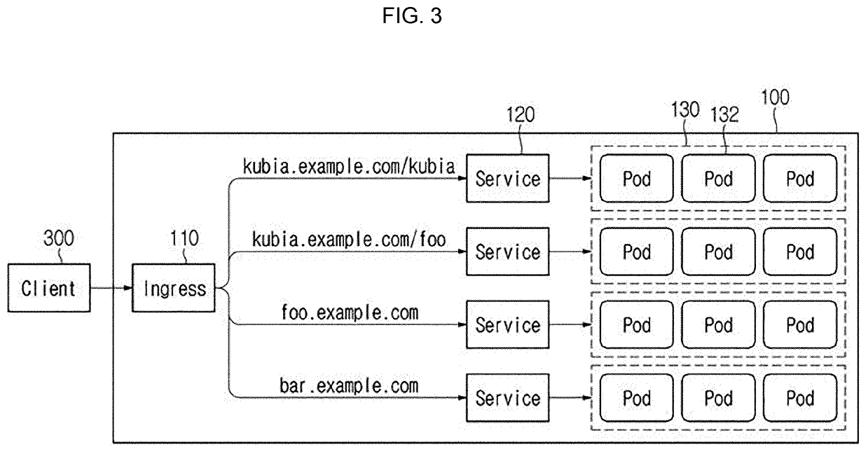

FIG. 3 is an exemplary diagram illustrating resource association between an ingress layer, a service layer, and an endpoint in the platform device for providing automated explanations for inference services based on artificial intelligence according to an embodiment of the present disclosure. Referring to FIG. 3, the ingress control related to the use of the inference container illustrated in FIG. 1 will be described in detail.

The platform device for providing automated explanations, that is, the cloud infrastructure 100 may be controlled to receive a request for use of the inference service of the user client 300 and send the request to the inference container 132 that performs the request for use. To this end, the cloud infrastructure 100 may have a sub-resource that includes an ingress layer 110 that first receives the request, a service layer 120, and an endpoint 130. The sub-resource may be managed by the processor 20 and the memory 30 of the cloud infrastructure 100.

The ingress layer 110 may be controlled to receive the inference request API of the user client 300 and send the received inference request API to the inference container 132. The ingress layer 110 is provided in a cloud native environment and may be used as an API gateway. The ingress layer 110 may utilize a single public IP within the cloud infrastructure 100 and distinguish inference services based on a URL. The ingress layer 110 may query a URL matching the inference service of the inference request and may send a web request packet according to the inference request to the endpoint of the inference service set in association with the queried URL, that is, the corresponding inference container 132. The URL may be a type of first access information required to access the inference container 132. The first access information may include not only a URL used by the ingress layer 110 to forward the inference request, but also location information of the endpoint 130 associated with the URL. The location information may be, for example, an IP address or a domain name. A URL form that may be utilized as the first access information may have, for example, an independent domain name. As illustrated in FIG. 3, independent domain names may be foo.example.com and bar.example.com. As another example, the URL form may be used in the form of being linked with a separate service endpoint by marking a sub-directory within a domain distinguished by “I” in the same domain name. As illustrated in FIG. 3, the URL form may be kubia.example.com/kubia, kubia.example.com/example.

The service layer 120 may query the location information of the inference container 132 mapped to the URL recognized from the ingress layer 110. The location information of the inference container 132 is checked through the endpoint 130 and may be substantially the same as the location information of the endpoint 130 included in the first access information. When the first access information for the inference container 132 is a dynamic IP address, the first access information may be dynamically changed according to settings of the cloud infrastructure 100. In this case, the inference request may be sent to the corresponding inference container 132 by the URL recognized by the ingress layer 110. Accordingly, in order for the service layer 120 to check the dynamic IP address of the inference container 132 with the same domain name as the URL of the inference container 132, the inference container 132 may have the container information including a static name (or identifier) of a container along with a dynamic IP address. The service layer 120 may map the domain name sent from the ingress layer 110 and the static name of the inference container 132 and send an inference request to an IP address corresponding to the mapped static name.

The endpoint 130 may store and manage the inference container 132 executing the inference request of the user client 300 in a designated pod. For example, the inference request may require to recognize an object included in an image or audio sent by a user to derive object information (e.g., a flower name in a flower image, a title of music, etc.). According to the above example, the inference container 132 may be a learning model that returns an inference result including object information to the user client 300. The inference container 132 may be, for example, a DNN which can provide estimation or prediction results according to in-depth analysis, and may be various learning models other than the DNN when the inference container 132 is a deep learning model. In order to receive a plurality of substantially same inference requests and quickly output an inference result, a plurality of inference containers 132 having many inference requests may be created to be allocated to the endpoint 130. As illustrated in FIG. 3, a plurality of pods designated as substantially the same inference container 132 may be provided to the endpoint 130.

As described above, the inference container 132 may be provided at the endpoint 130, and the endpoint 130 may be designated as the first access information for the inference request of the user client 300 to access the inference container 132. The first access information may be, for example, an IP address or a domain name of the inference container 132. In the case of the IP address, the first access information may be dynamically changed according to the setting of the cloud infrastructure 100. The domain name is an address defined as a text name corresponding to a dynamic IP address and may be maintained even if the IP address changes.

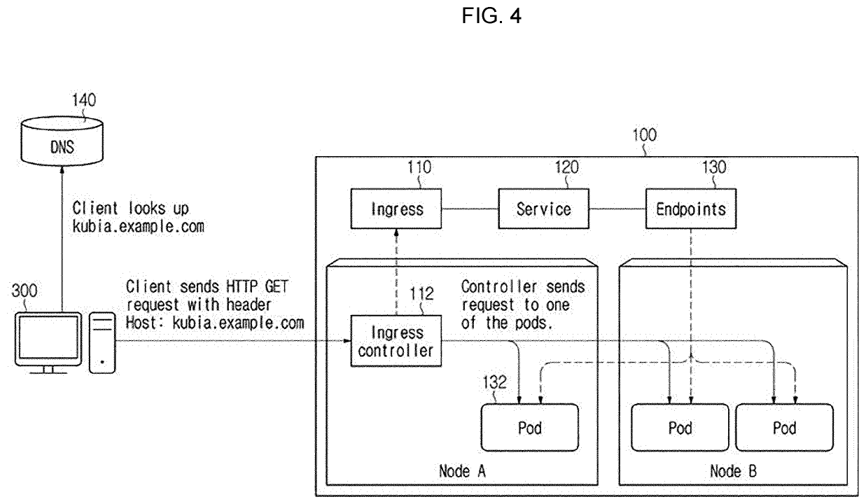

FIG. 4 is a diagram illustrating an operation of the ingress layer.

FIG. 4 illustrates a procedure performed in the layers 110 to 130 of the cloud infrastructure 100, and illustrates an operation procedure of a URL-service endpoint set through the ingress layer 110. FIG. 4 illustrates an example of sending a Hypertext Transfer Protocol (HTTP) request to a preset URL (kubia.example.com).

The inference request created by the user client 300 is sent to a domain name system (DNS) 140, and the DNS 140 may query an IP of a URL corresponding to the inference request. The DNS 140 may operate by being included in the cloud infrastructure 100. The user client 300 may send an HTTP GET request message using the IP queried through the DNS 140. In this case, the URL may be specified in the HTTP header. An ingress controller 112 that controls the ingress layer 110 may receive the corresponding request message and query the URL of the header. The ingress controller 112 may forward to the ingress layer 110 indicating the preset service endpoint 130. As described in FIG. 3, the inference request may be sent to the corresponding inference container 132 (or pod) via the ingress layer 110, the service layer 120, and the endpoint 130 by the ingress control.

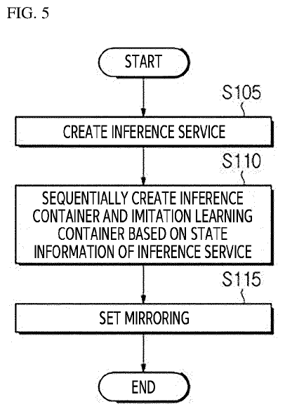

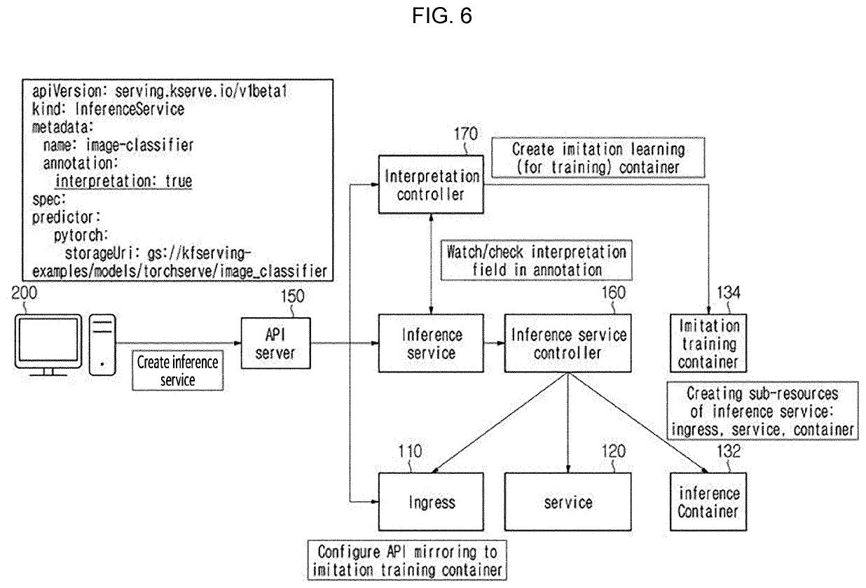

The creation of the imitation learning container and the mirroring setting performed in the method of providing automated explanations for inference services based on artificial intelligence according to an embodiment of the present disclosure will be described with reference to FIGS. 5 and 6.

FIG. 5 is a flowchart for creating an imitation learning container and a mirroring setting performed in a method of providing automated explanations for inference services based on artificial intelligence according to an embodiment of the present disclosure. FIG. 6 is an exemplary diagram illustrating a process in which the creating of the imitation learning container and the mirroring setting are implemented in the platform device for providing automated explanations according to an embodiment of the present disclosure.

Referring to FIG. 5, the cloud infrastructure 100 may create the inference service through the API server 150 according to the request of the provider client 200 (S105).

The processor 20 of the cloud infrastructure 100 may configure an inference service descriptor according to the request. The API server 150 may be a device constituting the cloud infrastructure 100. The request may include providing the imitation inference result and the interpretation information by an imitation learning container 134 (imitation training container) along with the inference result of the inference service. Accordingly, the inference service may be created based on the inference service descriptor. As illustrated at the upper left of FIG. 6, the inference service descriptor may include state information that includes an inference container name (or identifier), storage location information of the inference container 132, a learning model to be applied to the inference container 132, runtime information of the learning model, input/output specifications of the inference container 132, and the like. The storage location information of the inference container 132 may correspond to the first access information of the inference container 132. The storage location information may be, for example, a domain name or an IP address such as a URL.

As described above, the inference service descriptor may be created to activate an explanation field indicating the provision of the interpretation information by the request of the provider client 200 so that the imitation learning container 134 is created to provide the interpretation information. For example, as illustrated in the inference service descriptor at the upper left of FIG. 6, the provider client 200 may set a YAML-format metadata/annotation/explanation field (underlined part), that is, the explanation field, to a true value which is an activation value.

Next, the processor 20 may sequentially create the inference container 132 and the imitation learning container 134 based on the state information of the inference service (S110).

FIG. 6 illustrates that the inference container 132 is created by an inference service controller 160, and the imitation learning container 134 is created by an explanation controller 170. The inference service controller 160 and the interpretation controller 170 may be integrally implemented in the processor 20. Accordingly, the inference service controller 160 and the interpretation controller 170 may be modules or devices constituting the cloud infrastructure 100.

Specifically, the inference service controller 160 may create a sub-resource including the ingress layer 110, the service layer 120, and the inference container 132 based on the inference service descriptor related to the state information.

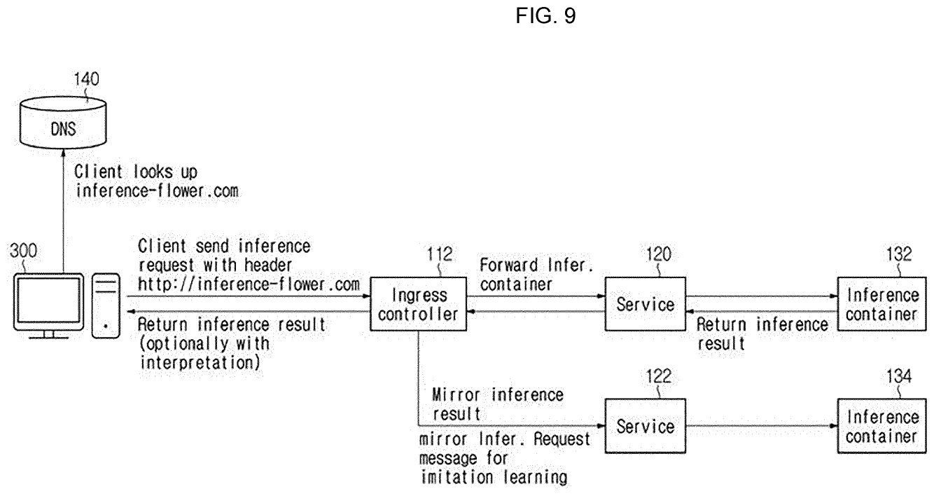

In addition, the interpretation controller 170 may recognize the activation value of the interpretation field and create the imitation learning container 134 based on the state information. The imitation learning container 134 may be created based on the container information including at least the inference container name (or identifier) and the learning model of the inference container 132 among the state information, the first access information of the inference container 132, the input/output specifications, and the like. The first access information may be, for example, an API URL of the inference container 132. Accordingly, as illustrated in FIG. 9, an imitation learning container 136 is designated as the pod of the endpoint 130 associated with the service layer 122 and managed by the ingress setting similar to that of the inference container 132.

The imitation learning container 134 may have a learning model independent of the inference container 132. For example, when the inference container 132 adopts a deep learning model such as DNN, the imitation learning container 134 sets input and output to conform to the input and output specifications of the inference container 132, and the imitation learning container 134 may be implemented as a lightweight learning model rather than the deep learning model. The learning model of the imitation learning container 134 may be configured to imitate the inference of the inference container using the set input and output. Accordingly, the imitation learning container 134 may provide the interpretation information including at least one of an input feature acting on the imitation inference result similar to the inference result of the inference container 132 and the importance of the input feature. Although the interpretation information is based on the imitation inference result, the interpretation information may be employed as information explaining the cause of the inference result.

The imitation learning container 134 may be, for example, a learning model such as a decision tree or a linear regression having a structure that a user can understand while imitating the input/output behavior of the deep neural network model such as the DNN. In the case of the decision tree, the input feature acting on the inference result and the importance of the input feature may be provided as the interpretation information based on the learning process and result by the decision tree.

Next, the processor 20, for example, the interpretation controller 170, may perform, based on the state information of the inference service descriptor, the mirroring setting that sends the inference request message requesting the use of the inference service and the inference response message according to the request to the imitation learning container 134.

The interpretation controller 170 may perform the mirroring setting based on the first access information of the inference container 132 defined in the descriptor of the inference service. In detail, the interpretation controller 170 may perform the ingress setting to mirror the inference request message or the like sent to the corresponding URL to the imitation learning container 134 based on the URL of the inference service predefined in the descriptor. Accordingly, the inference service descriptor may further include mirroring setting information including second access information for forwarding the inference request message or the like. The second access information may be created to have the IP address or the domain name of the imitation learning container for the API setting.

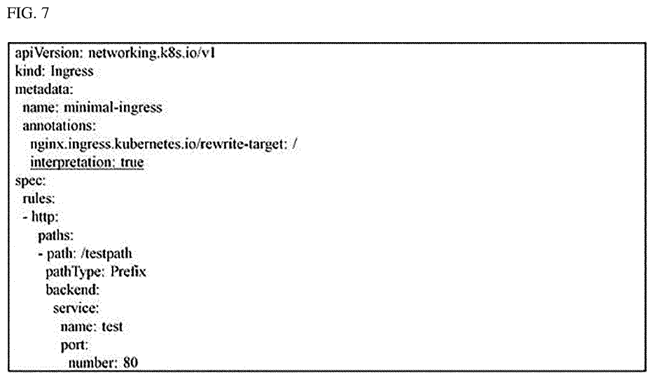

FIG. 7 is an exemplary diagram illustrating the inference service descriptor in which the mirroring is set by the ingress setting.

When an HTTP protocol and a URL path marked at a bottom of Spec-rule are a request designated as /testpath, the inference request message and the inference response message may be set to be sent to port No. 80 of a test service connected to the endpoint 130 of the inference container 132.

In the interpretation controller 170 setting the ingress for the mirroring, the API mirroring may be set by adding “nginx.ingress.kubernetes.io/mirror-target: https://test.env.com/$request_uri” to the metadata of the inference service descriptor of the ingress. The IP address or the domain name of the imitation learning container 134 may be input as a value of a mirror-target field.

The embodiment of FIG. 5 assumes that the inference container 132 to be actually operated is created and then the imitation learning container 134 is created. In another example, after the imitation learning container based on the inference service is created and the mirroring is set, when the inference request message based on the inference service is sent from the user client 300, an actual inference container may be created. Specifically, the processor 20, for example, the interpretation controller 170 may configure the imitation learning container based on the state information defined in the inference service descriptor according to the inference service created in operation S105. Subsequently, the interpretation controller 170 may perform the mirroring setting that sends the inference request message and the inference response message to the imitation learning container based on the state information. The state information and the mirroring setting are substantially the same as those described in FIG. 5. Next, the processor 20, for example, the inference service controller 160 may create a sub-resource according to the descriptor of the inference service in response to the inference request message received from the user client 300. The sub-resource may include an ingress layer, a service layer, and an inference container.

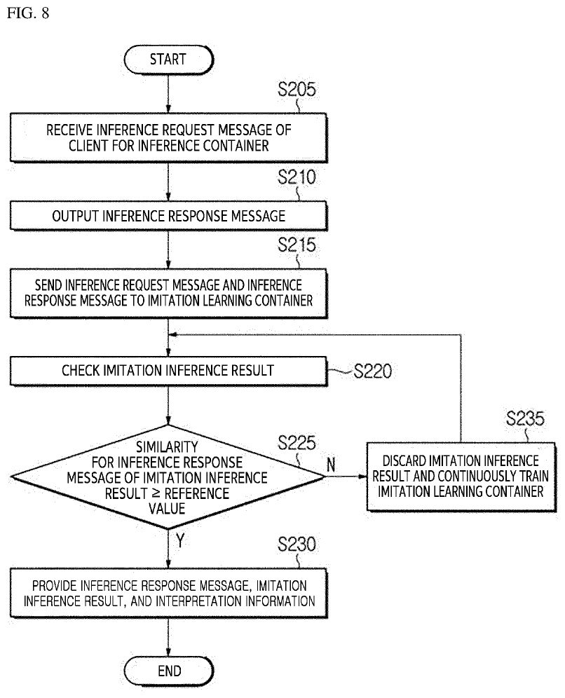

A method of providing automated explanations for inference services based on artificial intelligence according to an embodiment of the present disclosure will be described with reference to FIGS. 8 and 9.

FIG. 8 is a flowchart of a method of providing automated explanations for inference services based on artificial intelligence according to an embodiment of the present disclosure. FIG. 9 is a diagram illustrating an operation process of an inference container and an imitation learning container for each module in the platform device for providing automated explanations according to an embodiment of the present disclosure.

Referring to FIG. 8, the processor 20 of the cloud infrastructure 100 may receive the inference request message from the user client 300 and send the received inference request message to the corresponding inference container 132 (S205).

As illustrated in FIG. 4, the inference request message is sent to the DNS 140, and the DNS 140 may query the IP of the URL of the inference container 132 corresponding to the inference request. An HTTP GET request message may be transmitted to the processor 20, for example, the ingress controller 112 controlling the ingress layer 110, including the IP queried by the DNS 140. In this case, as illustrated in FIG. 9, a URL such as “http:”inference-flower.com may be specified in the header of the HTTP. The ingress controller 112 may receive the inference request message to query the URL of the header. The ingress controller 112 may forward to the ingress layer 110 indicating the preset service endpoint 130. Subsequently, the inference request may be sent to the corresponding inference container 132 via the ingress layer 110, the service layer 120, and the endpoint 130 by the ingress control.

Subsequently, the inference container 132 may output the inference response message to the inference container 132 according to the inference service based on the inference request message (S210).

The inference response message may be, for example, the inference result created by the deep learning model included in the inference container 132.

Next, the ingress controller 112 may send the inference request message and the inference response message to the imitation learning container 134 linked with the inference container 132 by the mirroring setting (S215).

The ingress controller 112 may send the messages to the imitation learning container 134 by referring to the second access information marked in the inference service descriptor related to the ingress.

Next, the imitation learning container 134 may output the imitation inference result according to the inference request message using its own learning model, and check the imitation inference result by comparing the imitation inference result and the inference result by the inference response message (S220).

Next, it may be determined whether the imitation learning container 134 satisfies the critical condition (S225).

The critical condition may be set as a condition in which the imitation inference result of the imitation learning container 134 has a similarity greater than or equal to a reference value with respect to the inference result according to the inference response message. Describing as an example, in the case where an inference request derives a flower name which is object information included in an image sent by a user, when the inference container 132 outputs a chrysanthemum as an inference result and when the imitation learning container 134 presents the chrysanthemum or a flower at least very similar to the chrysanthemum as an imitation learning result, the imitation learning container 134 may determine that the imitation inference result has a similarity greater than or equal to a reference value with respect to the inference result.

On the other hand, when the imitation learning container 134 presents a flower name that is not significantly similar to the chrysanthemum as the imitation learning result, the imitation learning container 134 may determine that the imitation inference result has a similarity lower than the reference value with respect to the inference result.

Subsequently, when the similarity of the imitation inference result to the inference response message is greater than or equal to the reference value (Y in S225), the ingress controller 112 may control to provide the imitation inference result and its interpretation information to the user client 300 together with the inference response message (S230).

The interpretation information may be created when the imitation inference result satisfies the critical condition with a similarity greater than or equal to the reference value. The interpretation information is information acting on the imitation inference result of the imitation learning container, and the information may explain the cause of the inference result. The interpretation information may include, for example, at least one of the input feature and the importance of the input feature. In the case where the imitation learning container has a learning model composed of a decision tree and the inference result is presented as the flower name described above, the input feature may be the form of a detailed object used to derive the inference result from the form of the detailed object such as a flower, a leaf, or a stem included in an image, and the importance of the input feature may be a weight of the detailed object, a node level located in a tree structure, and the like.

In contrast, when the similarity of the imitation inference result to the inference response message is less than the reference value (in the case of N in S225), the imitation learning container 134 may be controlled to discard the imitation inference result output in operation S210, and continuously train its own model and output the imitation inference result (S235).

After operation S235, the imitation learning container 134 may repeat operations S220 and S225 until the critical condition required in operation S225 is satisfied. Specifically, until the critical condition required in operation S225 is satisfied, the imitation learning container 134 may be learned again based on the inference request message, and may compare a subsequent imitation output result output by the learning with the inference result, and determine whether the subsequent imitation output result satisfies the critical condition. If satisfied, the imitation learning container 134 may create the interpretation information according to the imitation output result satisfying the critical condition, and transmit the imitation inference result and interpretation information to the ingress controller 112. The ingress controller 112 may separately provide the imitation inference result and the interpretation information to the user client 300. As another example, the ingress controller 112 may provide the imitation inference result and the interpretation information along with the inference response message.

In the above process, it has been described that the imitation learning container 134 compares the imitation output result and the inference result, but as another example, the ingress controller 112 may control to compare the imitation output result and the inference result, and provide the imitation reference result satisfying the critical condition and the interpretation information to the user client 300. In another example, when the ingress controller 112 determines that the imitation inference result does not satisfy the critical condition, the imitation learning container 134 may control to discard the imitation inference result and not to create the interpretation information.

According to the present disclosure, it is possible to provide a method, device, and system for providing automated explanations for inference services based on artificial intelligence that provides interpretation information on causality of inference through an imitation learning container operating independent of an inference container.

According to the present disclosure, an inference service provider and an inference service user can acquire interpretation information on an inference without performing a separate interpretation procedure. In detail, the inference service provider can receive an interpretation of the inference service without any additional request or operation, and the inference service user can also understand the reason for the inference result in more detail.

In addition, according to the present disclosure, a policy for the mirroring setting is added through ingress control, so HTTP-based and REST API-based inference request messages and inference response messages are sent to an endpoint of an imitation learning service for providing the interpretation.

According to the present disclosure, by adding a value of an annotation field to an inference service descriptor, it is possible to selectively and easily an interpretation function without modification from the user's point of view.

In addition to this, the interpretation function can be modeled so that inference service providers and users can be decoupled.

Effects which can be achieved by the present invention are not limited to the above-described effects. That is, other objects that are not described may be obviously understood by those skilled in the art to which the present invention pertains from the above detailed description.

Exemplary methods of the present disclosure are expressed as a series of operations for clarity of explanation, but this is not intended to limit the order in which steps are performed, and each step may be performed simultaneously or in a different order, if necessary. In order to implement the method according to the present disclosure, other steps may be included in addition to the exemplified steps, other steps may be included except for some steps, or additional other steps may be included except for some steps.

Various embodiments of the present disclosure are intended to explain representative aspects of the present disclosure, rather than listing all possible combinations, and matters described in various embodiments may be applied independently or in combination of two or more.

In addition, various embodiments of the present disclosure may be implemented by hardware, firmware, software, a combination thereof, or the like. For implementation by hardware, various embodiments of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

The scope of the present disclosure includes software or machine-executable instructions (e.g., operating systems, applications, firmware, programs, etc.) that cause operations according to the methods of various embodiments to be executed on a device or computer, and a non-transitory computer-readable medium in which such software, instructions, etc., are stored and executable on a device or computer.

What is claimed is:

1. A method of providing automated explanations for inference services based on artificial intelligence using a cloud, the method comprising:
requesting an inference response message to an inference container according to an inference service based on an inference request message received from a client;
sending the inference request message and the inference response message to an imitation learning container linked with the inference container according to a mirroring setting; and
creating interpretation information of the inference container based on the inference request message and the inference response message, and providing the created interpretation information to the client.

2. The method of claim 1, wherein the inference container and the imitation learning container have independent learning models, and the imitation learning container is trained to imitate an inference of the inference container.

3. The method of claim 1, wherein the imitation learning container is created based on an inference service descriptor used to create the inference service, and the inference service descriptor includes state information including first access information and input/output specifications of the inference container.

4. The method of claim 3, wherein the mirroring setting is performed by an ingress setting for mirroring the inference response message to the imitation learning container together with the sent inference request message based on the first access information.

5. The method of claim 3, wherein the inference service descriptor further includes an interpretation field indicating provision of the interpretation information and second access information of the imitation learning container, and
the interpretation field includes a value indicating whether to activate or not, and the second access information is created according to an ingress setting and has an Internet Protocol (IP) address or a domain name of the imitation learning container for an Application Program Interface (API) setting.

6. The method of claim 1, wherein the interpretation information includes at least one of an input feature that acts on an imitation inference result of the imitation learning container and an importance of the input feature.

7. The method of claim 1, wherein the creating of the interpretation information and the providing of the created interpretation information to the client includes providing an imitation inference result of the imitation learning container and the inference response message to the client along with the interpretation information when a critical condition is satisfied, and
the critical condition is set to a condition in which the imitation inference result of the imitation learning container has a similarity of a reference value or greater with respect to an inference result according to the inference response message.

8. The method of claim 7, wherein the creating of the interpretation information and the providing of the created interpretation information to the client further includes continuously training the imitation learning container until the critical condition is satisfied to output the imitation inference result, creating interpretation information of the imitation inference result that satisfies the critical condition, and discarding the imitation inference result that does not satisfy the critical condition.

9. The method of claim 1, further comprising:
prior to the requesting of the inference response message,
creating the inference service according to a request from the client;
sequentially creating the inference container and the imitation learning container based on state information of the inference service; and
performing a mirroring setting for sending the inference request message and the inference response message to the imitation learning container based on the state information, and
the state information includes first access information and input/output specifications of the inference container.

10. The method of claim 9, wherein the creating of the inference container includes creating a sub-resource including an ingress layer, a service layer, and an inference container based on the inference service.

11. A platform device for providing automated explanations for inference services based on artificial intelligence using a cloud, the platform device comprising:
a transceiver configured to transmit and receive a signal; and
a processor configured to process the signal,
wherein the processor is configured to request an inference response message to an inference container according to an inference service based on an inference request message received from a client,
send the inference request message and the inference response message to an imitation learning container linked with the inference container according to a mirroring setting, and
create interpretation information of the inference container and provide the created interpretation information to the client when the imitation learning container is trained based on the inference request message and the inference response message to satisfy a provision condition.

12. The platform device of claim 11, wherein the inference container and the imitation learning container have independent learning models, and the imitation learning container is trained to imitate an inference of the inference container.

13. The platform device of claim 11, wherein the imitation learning container is created based on an inference service descriptor used to create the inference service, and the inference service descriptor includes state information including first access information and input/output specifications of the inference container.

14. The platform device of claim 13, wherein the mirroring setting is performed by an ingress setting for mirroring the inference response message to the imitation learning container together with the sent inference request message based on the first access information.

15. The platform device of claim 13, wherein the inference service descriptor further includes an interpretation field indicating provision of the interpretation information and second access information of the imitation learning container, and
the interpretation field includes a value indicating whether to activate or not, the second access information is created according to an ingress setting and has an Internet Protocol (IP) address or a domain name of the imitation learning container for an Application Program Interface (API) setting.

16. The platform device of claim 11, wherein the interpretation information includes at least one of an input feature that acts on an imitation inference result of the imitation learning container and an importance of the input feature.

17. The platform device of claim 11, wherein the creation of the interpretation information and the provision of the created interpretation information to the client includes, by the processor, providing an imitation inference result of the imitation learning container and the inference response message to the client along with the interpretation information when a critical condition is satisfied, and
the critical condition is set to a condition in which the imitation inference result of the imitation learning container has a similarity of a reference value or greater with respect to an inference result according to the inference response message.

18. The platform device of claim 17, wherein the processor is configured to continuously train the imitation learning container until the critical condition is satisfied to output the imitation inference result, create interpretation information of the imitation inference result that satisfies the critical condition, and discard the imitation inference result that does not satisfy the critical condition.

19. The platform device of claim 11, wherein the processor is configured to create the inference service according to a request from the client,
sequentially create the inference container and the imitation learning container based on state information of the inference service, and
perform a mirroring setting for sending the inference request message and the inference response message to the imitation learning container based on the state information, and
the state information includes first access information and input/output specifications of the inference container.

20. A system for providing automated explanations for inference services based on artificial intelligence using a cloud, the system comprising:
a client configured to request creation or use of an inference service; and
a platform device for providing automated explanations for inference services including a processor that processes a request for the inference service,
wherein the processor is configured to request an inference response message to an inference container according to an inference service based on an inference request message received from a client,
send the inference request message and the inference response message to an imitation learning container linked with the inference container according to a mirroring setting, and
create interpretation information of the inference container and provide the created interpretation information to the client when the imitation learning container is trained based on the inference request message and the inference response message to satisfy a provision condition.
